(19) United States
(12) Patent Application Publication
(10) Pub. No.: US 2012/0143645 A1
(43) Pub. Date: Jun. 7, 2012

(54) SYSTEM AND METHOD FOR MANAGING AGENT OWNED RECALL AVAILABILITY

(75) Inventor: Shriwallabh Aghor, Pune (IN)

(73) Assignee: AVAYA INC., Basking Ridge, NJ (US)

(21) Appl. No.: 12/959,221

(22) Filed: Dec. 2, 2010

(51) Int. Cl. G06Q 10/00

(52) U.S. Cl. 705/7.19

(57) ABSTRACT

Embodiments of the present invention generally relate to a system and method for managing agent owned recall availability in a contact center. In one embodiment of the present invention, there is provided a method for managing agent owned recall availability in a contact center, comprising providing a work force management engine; providing an agent availability database accessible by the work force management engine; receiving a parameter-specified request from a contact for agent owned recall availability; querying the work force management engine to determine agent owned recall availability data for the parameter-specified request; reserving the agent owned recall availability slot for the parameter-specified request; updating the work force management engine with the reserved parameter-specified agent owned recall availability slot data; and confirming the agent owned recall availability slot with the contact of the parameter-specified request.

### BACKGROUND OF THE INVENTION

1. Field of the Invention

Embodiments of the present invention generally relate to customer/contact care management at contact centers and more particular to a system and method for managing agent owned recall availability at contact centers.

2. Description of Related Art

Contact centers that utilize IVR systems employ automated procedures to distribute customers' (hereinafter also referred to as “contacts”) specific transaction requests to available contact center agents, who are employed to handle those particular transactions requested by the contact. According to certain automated procedures, an attempt is made to match a contact's requested transaction to the best-qualified agent having the skills to handle the particular requirements identified for that transaction.

In performing a match, utilizing an IVR system, contacts (e.g., customer calls) are often placed in queues, which are then serviced by specific groupings of agents. The term “contacts” includes but is not limited to customers who call or make contact with a contact center, using a wired and wireless telephone, cellular telephone, VoIP telephone, Skype-like systems and the like, whereby a customer may connect with an IVR system of a contact center by any of the aforementioned or equivalent means. For simplicity, the terms “call” or “calls” are used to include but not be limited to any of the above or equivalent means of connecting with a contact center.

On occasion, after a contact and an agent are matched, for one reason or another, the contact may disconnect or disengage from the agent and the contact is dropped from the agent at the contact center. This may be caused by the contact abruptly disconnecting, the agent disconnecting or the session being completed or substantially completed for the moment. Although some contact centers permit a customer contact to “opt out” under specified circumstances, the contact centers usually wait for the call to be delivered to the agent before calling back the caller. Such contact center products, for example, are offered by Genesys and Zeacom. These products allow a contact to maintain his or her place in the queue and to have the system reconnect with the contact once the contact, e.g., the customer call, is delivered to the agent. These known products virtually maintain the caller's place in queue without the caller having to be physically connected.

The failure to synchronize the initiation of the contact with the agent ready to service the contact can unnecessarily tie up contact center resources, however, such as the servicing agent waiting for the contact to respond and lengthen the time required for the contact to receive service or complete its transaction. In addition, after a contact has been working with a matched up agent, the contact may wish to be reconnected with the same agent from the previous agent session for continuity purposes and to save valuable time and contact center resources. In these situations, a process or feature known as Agent Owned Recall is implemented.

The Agent Owned Recall (AOR) feature allows an agent on an outbound call to set a specific recall time for a customer/contact record. This will mark the record as an “agent owned recall” record. Avaya's Proactive Contact System, Software Version 4.2 (PC4) The PC4 will then make the recall when the specified time occurs and pass the call to the agent that owns that recall in an attempt to reconnect with the contact. The AOR feature may be executed, by way of example only, via the Avaya PC4 server.

Although this AOR feature allows the agent to set the recall for the contact, where the system intends to have the same agent recall the contact when the call happens, presently there is no guaranty the same agent will have 100% availability to re-connect with the contact at the prescribed date and time. For example, when the actual recall occurs, if the particular agent is not available, the call may be routed to the next available agent, defeating the main purpose of the AOR feature.

Presently, this failure usually falls into two categories: The first category is where not enough validation is done before promising the recall date and time and the agent availability to the contact. The second category occurs in cases where, when the agent is not available, the contact is not notified and arbitrarily connected to a different agent. The contact's expectations are thus not met.

Although known AOR features and processes assist in somewhat satisfying contacts' needs, this is not always the case. Furthermore, precious automated processing resources, as well as service agent and manager resources, are utilized and expended in an effort to re-connect a contact to the same agent where a disconnect has occurred.

Thus, there is a need for a system and method for managing AOR availability at contact centers such that the likelihood of a re-connect between a contact and the agent with whom he/she wishes to re-connect will occur substantially every time. There is a further need to establish this AOR while minimizing processing resources to re-connect the contact with the agent from a previously disconnected session.

### SUMMARY

Embodiments of the present invention generally relate to a method for managing agent owned recall availability in a contact center.

In accordance with one embodiment of the present invention, there is provided a method for managing agent owned recall availability in a contact center, comprising providing a work force management engine; providing an agent availability database accessible by the work force management engine; receiving a parameter-specified request from a contact for agent owned recall availability; querying the work force management engine to determine agent owned recall availability data for the parameter-specified request; reserving the agent owned recall availability slot for the parameter-specified request; updating the work force management engine with the reserved parameter-specified agent owned recall availability slot data; and confirming the agent owned recall availability slot with the contact of the parameter-specified request. The parameter-specified request may comprise a date the agent is available, a time the agent is available, or a date and a time the agent is available.

In a further embodiment, if during the querying step, an agent owned recall availability conflict exists with the parameter-specified request, the method further comprises suggesting to the contact an alternative slot to the parameter-specified request.

In yet another embodiment, if after suggesting an alternative, the agent owned recall availability conflict is resolved, the work force management engine is updated with the reserved parameter-specified agent owned recall availability slot data and the request is confirmed with the contact. Alternatively, if after suggesting an alternative, the agent owned recall availability conflict is not resolved, the method further comprises setting the expectations of the contact. The step of setting the expectations of the contact may comprise informing the contact that the recall will be a general recall and not an agent owned recall. The step of reserving an availability slot may further comprise reserving a predetermined amount of time before the slotted agent owned recall is to occur.

In accordance with another embodiment of the present invention, there is provided a system for managing agent owned recall availability in a contact center, comprising a computer server, comprising a work force management engine; and an agent availability database accessible by the work force management engine, the database comprising date and time parameters of agents; receiving means for receiving a parameter-specified request from a contact for agent owned recall availability; querying means for querying the work force management engine to determine agent owned recall availability slot data for the parameter-specified request; reserving means within the work force management engine for reserving the agent owned recall availability slot for the parameter-specified request; updating means within the work force management engine for updating the work force management engine with the reserved parameter-specified agent owned recall availability slot data; and confirming means for confirming the agent owned recall availability slot with the contact of the parameter-specified request. The work force management engine may further comprise a schedule call back task delineator. In a further embodiment, the schedule call back task delineator is capable of blocking a date slot or a time slot for the agent so the agent is not assigned any other task on that date and the date is blocked for the agent owned recall outbound work. The task delineator is capable of blocking additional predefined time before the agent owned recall time slot.

In accordance with another embodiment of the present invention, there is provided a system, comprising a computer server, the computer server comprising a tangible computer readable medium, the medium comprising program instructions, wherein the program instructions are computer-executable to implement providing a work force management engine; providing a searchable agent availability database accessible by the work force management engine; receiving a parameter-specified request from a contact for agent owned recall availability data; querying the work force management engine to determine agent owned recall availability data for the parameter-specified request; reserving the agent owned recall availability slot for the parameter-specified request; updating the work force management engine with the reserved parameter-specified agent owned recall availability slot data; and confirming the agent owned recall availability slot with the contact of the parameter-specified request; whereby the same agent is available to the contact for the agent owned recall.

### BRIEF DESCRIPTION OF THE DRAWINGS

So the manner in which above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments encompassed within the scope of the present invention, and, therefore, are not to be considered limiting, for the present invention may admit to other equally effective embodiments, wherein:

FIG. 1 is a block diagram depicting a contact center in accordance with an embodiment of the present invention;

FIG. 2 is a block diagram depicting a server of the contact center of FIG. 1 in accordance with an embodiment of the present invention;

FIG. 3 is system block diagram of the server of FIG. 2, depicting the work force management engine and peripherals in accordance with an embodiment of the present invention; and

FIG. 4 is a flow chart depicting a method for validating agent owned recall availability in accordance with another embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

Embodiments of the present invention generally relate to customer care management at contact centers and more particular to a system and method for managing agent owned recall (AOR) features at contact centers.

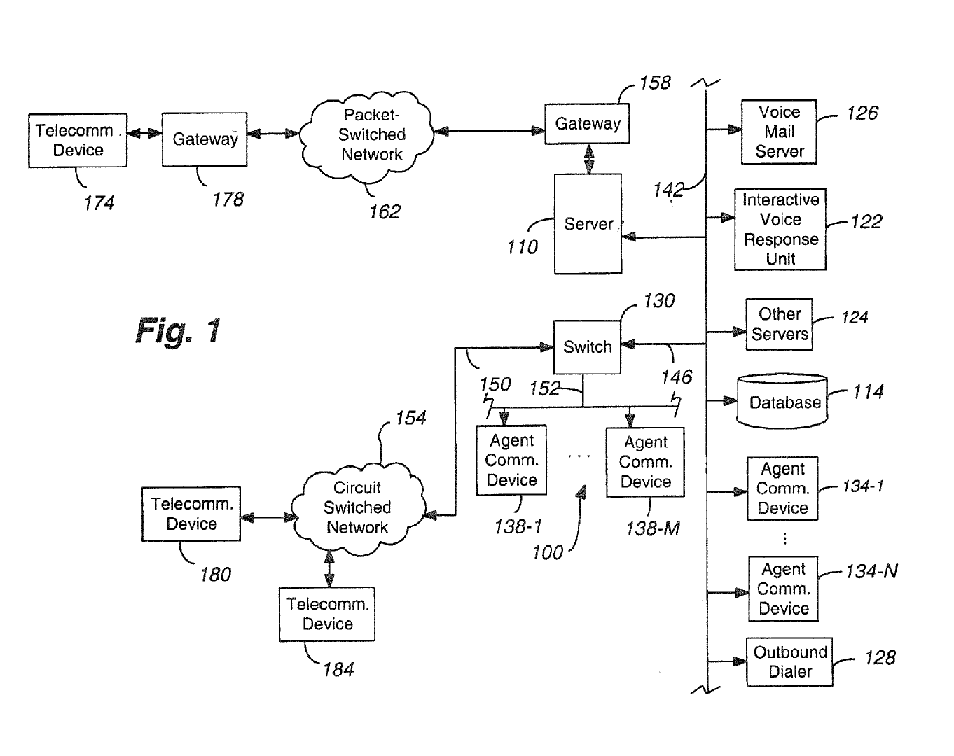

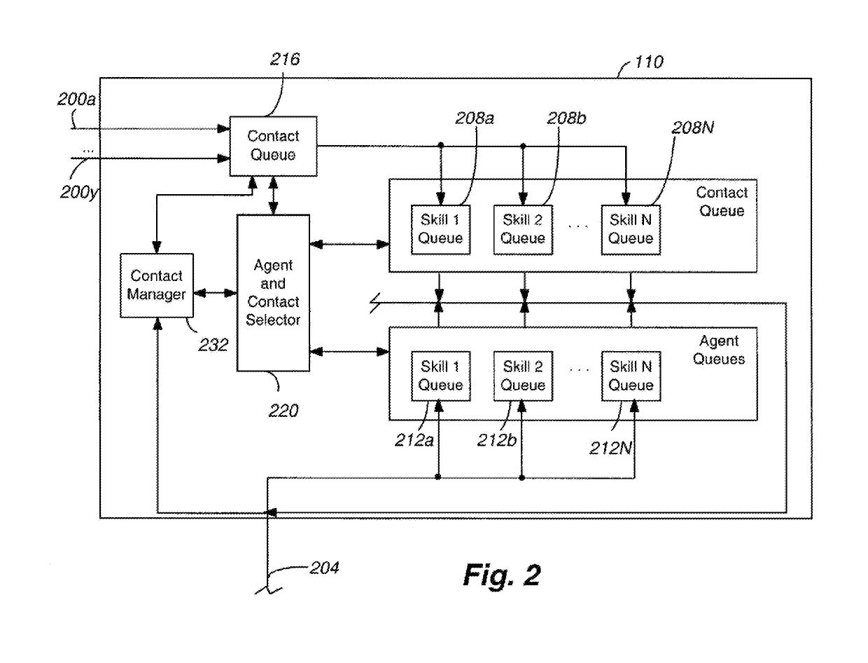

FIG. 1 depicts an illustrative embodiment of a contact center of the present invention where contact center agents may service their assigned contacts, either singularly or in multiples, simultaneously or substantially simultaneously. A contact center 100 comprises a central server 110 (described in more detail in connection with FIG. 2), a set of data stores or databases 114, which may or may not be contained within the central server 110, a database 114, representing one or more databases, containing agent metrics, contact or customer related information, agent availability data, and other information that can enhance the value and efficiency of the contact's experience, and a plurality of servers, namely a voice mail server 126, an Interactive Voice Response (IVR) unit/system 122, and other servers 124, an outbound dialer 128, a switch 130, a plurality of working agents operating packet-switched (first) telecommunication devices 134-1 to N (such as computer work stations or personal computers or handheld communication devices including wireless communication devices), and/or circuit-switched (second) telecommunication devices 138-1 to M, all interconnected by a local area network LAN (or wide area network WAN) 142.

The servers can be connected via optional communication lines 146 to the switch 130. As will be appreciated, the other servers 124 can also include a scanner (which is normally not connected to the switch 130 or Web server), VoIP software, video call software, voice messaging software, an IP voice server, a fax server, a web server, and an email server) and the like. The switch 130 is connected via a plurality of trunks 150 to the Public Switch Telecommunication Network (PSTN) 154 and via link(s) 152 to the second telecommunication devices 138-1 to M. A gateway 158 is positioned between the server 110 and the packet-switched network 162 to process communications passing between the server 110 and the network 162.

The term “switch” or “server” as used herein should be understood to include a PBX, an ACD, an enterprise switch, or other type of telecommunications system switch or server, as well as other types of processor-based communication control devices such as media servers, computers, adjuncts, etc.

The server and/or switch can be a software-controlled system including a processing unit (CPU), microprocessor, or other type of digital data processor executing software or an Application-Specific Integrated Circuit (ASIC) as well as various portions or combinations of such elements.

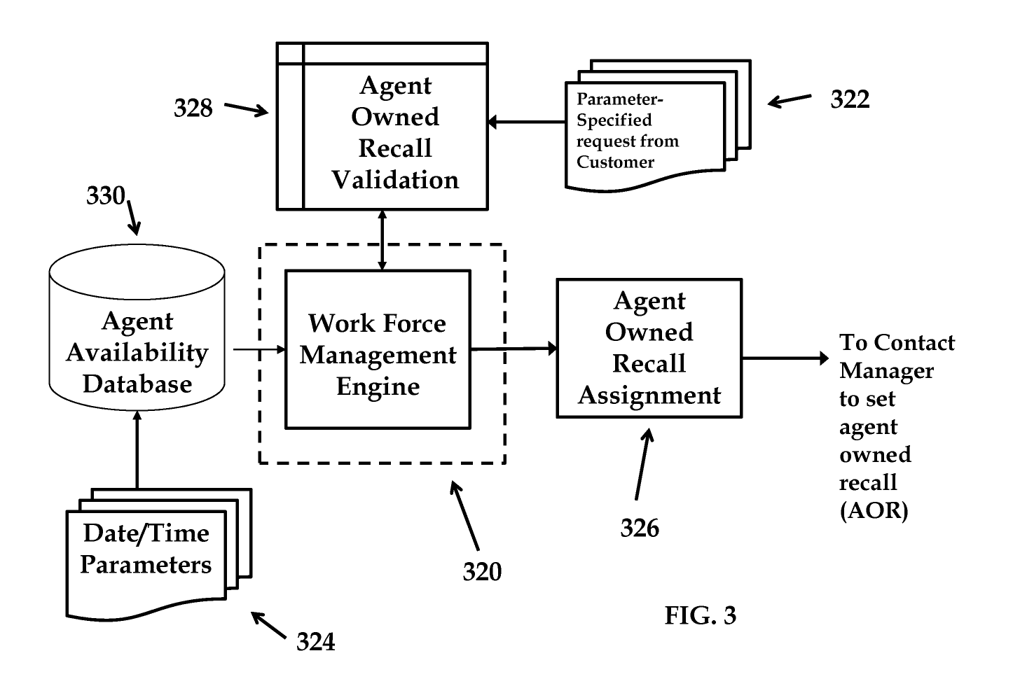

Referring to FIG. 2, one possible configuration of the server 110 is depicted. The server 110 is in communication with a plurality of customer communication lines 200a-y (which can be one or more trunks, phone lines, etc.) and agent communication line 204 (which can be a voice-and-data transmission line such as LAN 142 and/or a circuit switched voice line) and which may be in communication with the work force management engine and its peripherals (see FIG. 3). The server 110 can include a Basic Call Management System (BCMS) (not shown) and a Call Management System (CMS) (not shown) that gathers call records and contact-center statistics for use in generating contact-center reports.

The switch 130 and/or server 110 can be any computer and/or telecommunication architecture for directing contacts to one or more telecommunication devices to be serviced by one or more agents. Illustratively, the switch and/or server can be a modified form of the subscriber-premises equipment disclosed in U.S. Pat. Nos. 6,192,122; 6,173,053; 6,163,607; 5,982,873; 5,905,793; 5,828,747; and 5,206,903, all of which are incorporated herein by this reference; Avaya Inc.'s Definity™ Private-Branch Exchange (PBX)-based ACD system; MultiVantage® PBX, CRM Central 2000 Server™; Communication Manager™, and/or 58300™ media server.

Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. The switch and/or server typically include a network interface card (NIC) (not shown) to provide services to the serviced telecommunication devices. Other types of known switches and servers are well known in the art and therefore not described in detail herein.

Referring again to FIG. 2, included among the data stored in the server 110 is a set of contact queues 208a-n and a separate set of agent queues 212a-n. Each contact queue 208a-n corresponds to a different set of agent skills, as does each agent queue 212a-n. Conventionally, contacts are prioritized and are either enqueued in individual ones of the contact queues 208a-n in their respective orders of priority or are enqueued in different ones of a plurality of contact queues that correspond to a different priority.

Likewise, each agent's skills are prioritized according to his or her level of expertise in that skill, and either agents are enqueued in individual ones of agent queues 212a-n in their order of expertise level or are enqueued in different ones of a plurality of agent queues 212a-n that correspond to a skill. Each one of which corresponds to a different expertise level.

A contact vector (queue) 216 is included among the control programs in the server 110. Contacts incoming to the contact center are assigned by contact vector 216 to different contact queues 208a-n based upon a number of predetermined criteria, including customer identity, customer needs, contact center needs, current contact center queue lengths, customer value, and the agent skill required for the proper handling of the contact.

Agents who are available for handling contacts are assigned to agent queues 212a-n based upon the skills they possess. An agent may have multiple skills, and hence may be assigned to multiple agent queues 212a-n simultaneously. Furthermore, an agent may have different levels of skill expertise (e.g., skill levels 1-N in one configuration or merely primary skills and secondary skills in another configuration), and hence may be assigned to different agent queues 212a-n at different expertise levels. Call vectoring is described in DEFINITY Communications System Generic 3. Call Vectoring/Expert Agent Selection (EAS) Guide, AT&T publication no. 555-230-520 (Issue 3, November 1993). Skills-based ACD is described in further detail in U.S. Pat. Nos. 6,173,053 and 5,206,903.

Referring again to FIG. 1, the gateway 158 can be Avaya Inc.'s, G700 Media Gateway™, and may be implemented as hardware such as via an adjunct processor (as shown) or as a chip in the server.

The first telecommunication devices 134-1, . . . 134-N are packet-switched and can include, for example, IP hardphones such as the Avaya Inc.'s 4600 Series IP Phones™, IP softphones such as Avaya Inc.'s IP Softphone™, Personal Digital Assistants or PDAs, Personal Computers or PCs, laptops, packet-based H.320 video phones and conferencing units, packet-based voice messaging and response units, and packet-based traditional computer telephony adjuncts.

The second telecommunication devices 138-1, . . . 138-M are circuit-switched. Each of the telecommunication devices 138-1, . . . 138-M corresponds to one of a set of internal extensions Ext1, . . . ExtM, respectively. These extensions are referred to herein as “internal” in that they are extensions within the premises directly serviced by the switch. More particularly, these extensions correspond to conventional telecommunication device endpoints serviced by the switch/server, and the switch/server can direct incoming contacts or calls to, and receive outgoing contacts or calls, from these extensions in a conventional manner. The second telecommunication devices can include, for example, wired and wireless telephones, PDAs, H.320 video phones and conferencing units, voice messaging and response units, and traditional computer telephony adjuncts.

It should be noted the present invention does not require any particular type of information transport medium between switch or server and first and second telecommunication devices. That is, the present invention may be implemented with any desired type of transport medium as well as combinations of different types of transport media.

The packet-switched network 162 can be any data and/or distributed processing network, such as the Internet. The network 162 typically includes proxies (not shown), registrars (not shown), and routers (not shown) for managing packet flows.

The packet-switched network 162 is in (wireless or wired) communication with an external first telecommunication device 174 via a gateway 178, and the circuit-switched network 154 with an external (wired) second telecommunication device 180 and (wireless) third telecommunication device 184. These telecommunication devices are referred to as “external” in that they are not directly supported as telecommunication device endpoints by the switch or server. The telecommunication devices 174 and 180 are an example of devices more generally referred to herein as “external endpoints.”

In one configuration, the server 110, network 162, and first telecommunication devices 134 are Session Initiation Protocol (SIP) compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be understood the configuration of the switch, server, user telecommunication devices, and other elements as shown in FIG. 1 is for purposes of illustration only and should not be construed as limiting the present invention to any particular arrangement of elements.

As will be appreciated, the central server 110 is notified via LAN 142 of an incoming contact (e.g., a call) by the telecommunications component (e.g., switch 130, fax server, email server, web server, and/or other server) receiving the incoming contact. The incoming contact is held by the receiving telecommunications component until the server 110 forwards instructions to the component to forward or route the contact to a specific contact center resource, such as the IVR unit 122, the voice mail server 126, and/or first or second telecommunication devices 134, 138 associated with a selected agent.

The server 110 distributes and connects these contacts to telecommunication devices of available agents based on the predetermined criteria noted above. When the central server 110 forwards a voice contact to an agent, the central server 110 also forwards customer-related information from databases 114 to the agent's computer work station for viewing (such as by a pop-up display) to permit the agent to better serve the customer. The agent will then process the contact(s) sent to him/her by the server 110.

According to embodiments of the present invention, included among the programs executing on the server 110 are an agent and contact selector 220 and contact manager 232. The selector 220 and manager 232 are stored either in the main memory or in a peripheral memory (e.g., disk, CD ROM, etc.) or some other computer-readable medium of the center 100. The selector 220 and manager collectively effect an assignment between available contacts in a queue and available agents serving the queue (either singularly or in multiple assignments) in a way that tends to maximize contact center efficiency.

The selector 220 comprises a work force management engine 320, see FIG. 3 for more detail, which functions to coordinate agent availability for an agent owned recall. In an embodiment, the contact manager 232 receives a parameter-specified request from a contact by way of the selector 220, which selector has determined and identified, in addition to matching agent with contact dependant on skills matched, the then current agent availability data of the selected agent for agent owned recall availability, and depending on whether that agent is available, provides instructions to the selector 220 to effect same.

The contact manager 232, based on agent availability slots, may determine whether to inform the contact that its request has been satisfied and the contact will be assigned to the same agent for an agent owned recall.

It is understood by embodiments of the present invention that a server, such as the one depicted in FIG. 2, may be connected to a computer network or system. A computer network includes the Internet, a global computer network, an internal computer network, dedicated server networks, and the like.

Referring to FIG. 3, which details the work force management engine 320 and peripherals of the agent and contact selector 220 of FIG. 2, there is provided within the selector the work force management engine 320 and the agent availability database 330. Agent availability data 324 is stored in the agent availability database 330. The type of availability data stored is comprised from a group of temporal parameters such as dates and times that agents are available for agent owned recall sessions.

It is to be understood that although embodiments of the present invention are described as gathering date and time data for an agent, these and other parameters equally apply to more than one agent and in fact may apply to as many agents contained within a contact center or multiple contact centers at any given time. Furthermore, while embodiments of the present invention are described in connection with one contact center, it should be understood that it is within the scope of the present invention that these same systems and methods are scalable to be applied to one or more agents at more than one contact center at any given time.

For example, although the description of the server 110, the agent and contact selector 220 and their respective sub-elements are discussed in the singular, it is understood that these elements 110 and 220 may represent multiple contact centers or each contact center may include one or more of these servers 110 and agent/contact selectors 220, or any combinations thereof. The system and method is described herein in the singular for purposes of clarity only.

In operation, referring to FIGS. 2 and 3, when a parameter-specified request from a contact 322 is received from the gateway 158 (FIG. 1) and queued on the communication lines 200a-y, the agent and contact selector 220 begins the process of querying the work force management engine 320. This includes employing the agent owned recall validation module in connection with the work force management engine 320 to review the agent availability database 330 for agent availability slots. In addition, however, as contemplated by embodiments of the present invention, the agent and contact selector 220 performs an additional process of determining whether an agent, who has been matched up with the contact because of its agent owned recall status, is servicing additional contacts at substantially the same time as servicing the initial contact. If so, this may present a conflict.

Preferably prior to making this decision as to whether an agent is available to perform an agent owned recall at the date and/or time requested by the contact, the agent's then current availability data is stored in a database 330. Such data is continuously collected and updated prior to the current session of querying agent availability. Therefore, this availability data can be sourced from months, weeks, or days ago, to as recently as information from a t-1 agent/contact session, i.e., the agent/contact session just prior to the current agent/contact session.

Once this information regarding the agent's availability data is stored, the agent's then current availability is reserved as an agent owned recall assignment 326. The assignment 326 then delivers this blocked date and or time slot to the Contact Manager to report to the contact. Once the assignment slot 326 is blocked, the work force management engine is updated with the reserved parameter-specified agent owned recall availability slot data, thus preventing another agent owned recall to be assigned to that particular agent for that same date and/or time slot.

An advantage of embodiments of the present invention is the ability to ensure that the contact is called back by the same agent that was first assigned to the contact. In this way, the contact is not disappointed with a general call back from a different agent. That is, if a contact is expecting an agent owned recall and instead receives a general recall, the contacts expectations fall short, which would be detrimental to the contact or customer satisfaction levels required in the contact centers.

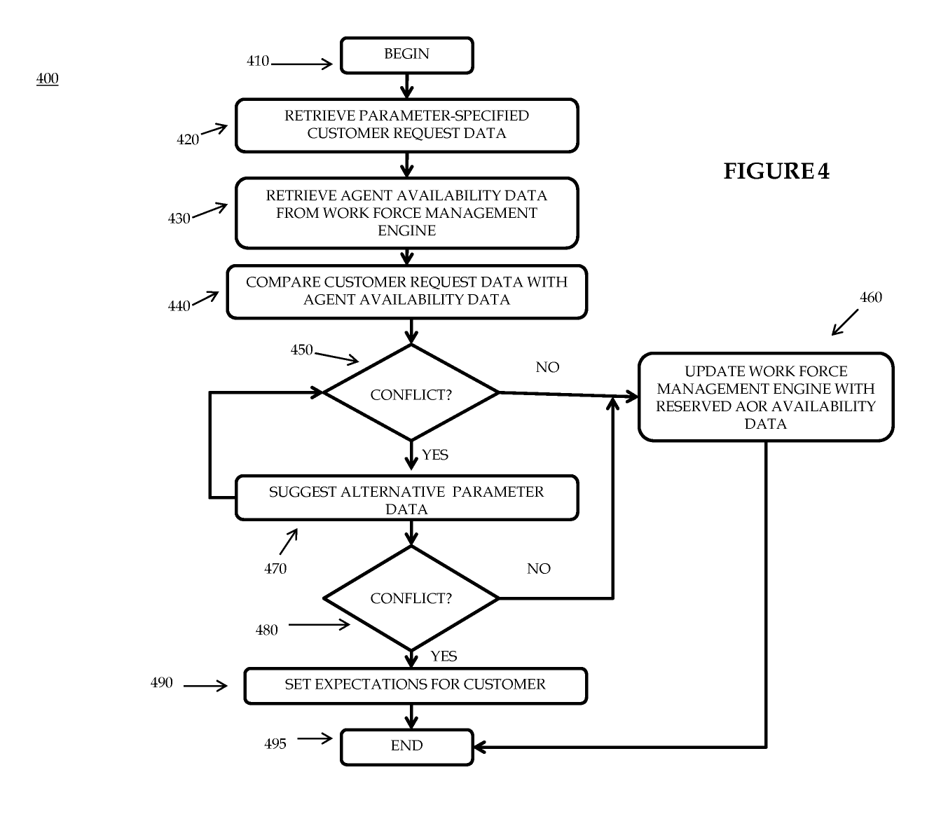

In accordance with one embodiment of the present invention, utilizing the systems described in FIGS. 1-3, there is provided a method 400 for managing agent owned recall availability in a contact center, which is depicted in FIG. 4. The method begins at step 410. At step 420, the system retrieves parameter-specified customer request data from the contact or customer. This may comprise a date when the contact wishes a recall from the same agent the contact was communicating with during a previous disconnected contact session.

At step 430, the system retrieves agent availability data from the agent availability database 330 of the work force management engine 320 to determine if the agent is available for an agent owned recall.

At step 440, the parameter-specified customer request data is compared to the agent availability data to determine if a date and/or time slot is available. A conflict decision is then determined at step 450. If there is no conflict, then at step 460, the work force management engine is updated with the reserved or blocked out parameter slot, which may comprise a date, a time or a date and time, at which the agent will make an agent owned recall to the contact who requested same.

If, on the other hand, there is a conflict, then the system goes to step 470, which provides the contact with a suggested alternative parameter, such as an alternative date or an alternative time or both an alternative date and alternative time. If, after providing the contact with alternative parameters, there is no conflict, then, at step 460, the work force management engine is updated with the reserved blocked slot for the agent owned recall for a schedule call back.

If, on the other hand, there is still a conflict that cannot be resolved, at step 490, expectations for the customer or contact are then set. Such expectations may include that the contact is informed he or she will be given a general call back and not the agent owned recall as he or she had originally expected. Alternatively while reserving the AOR timings in time and attendance, predefined time is added before the recall and for call duration to avoid overbooking of agent.

After either step 460, where the conflict has been resolved, or at step 490, where the conflict could not be resolved and the contact's expectations have been set, the method ends at step 495 until the next contact parameter-specified request is made.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein.

What is claimed is:

1. A method for managing agent owned recall availability in a contact center, comprising:
providing a work force management engine;
providing an agent availability database accessible by the work force management engine;
receiving a parameter-specified request from a contact for agent owned recall availability;
querying the work force management engine to determine agent owned recall availability data for the parameter-specified request;
reserving the agent owned recall availability slot for the parameter-specified request;
updating the work force management engine with the reserved parameter-specified agent owned recall availability slot data; and
confirming the agent owned recall availability slot with the contact of the parameter-specified request.

2. The method of claim 1, wherein the parameter-specified request comprises a date the agent is available.

3. The method of claim 1, wherein the parameter-specified request comprises a time the agent is available.

4. The method of claim 1, wherein the parameter-specified request comprises a date and a time the agent is available.

5. The method of claim 1, wherein, if during the querying step, an agent owned recall availability conflict exists with the parameter-specified request, the method further comprises suggesting to the contact an alternative slot to the parameter-specified request.

6. The method of claim 5, wherein, after suggesting an alternative, the agent owned recall availability conflict is resolved, the work force management engine is updated with the reserved parameter-specified agent owned recall availability slot data and the request is confirmed with the contact.

7. The method of claim 5, wherein, after suggesting an alternative, the agent owned recall availability conflict is not resolved, the method further comprises setting the expectations of the contact.

8. The method of claim 7, wherein the step of setting the expectations of the contact comprises informing the contact that the recall will be a general recall and not an agent owned recall.

9. The method of claim 1, wherein the step of reserving an availability slot comprises reserving a predetermined amount of time before the slotted agent owned recall is to occur.

10. A system for managing agent owned recall availability in a contact center, comprising:
a computer server, comprising:
a work force management engine; and
an agent availability database accessible by the work force management engine, the database comprising date and time parameters of agents;
receiving means for receiving a parameter-specified request from a contact for agent owned recall availability;
querying means for querying the work force management engine to determine agent owned recall availability slot data for the parameter-specified request;
reserving means within the work force management engine for reserving the agent owned recall availability slot for the parameter-specified request;
updating means within the work force management engine for updating the work force management engine with the reserved parameter-specified agent owned recall availability slot data; and
confirming means for confirming the agent owned recall availability slot with the contact of the parameter-specified request.

11. The system of claim 10 wherein the work force management engine comprises a schedule call back task delineator.

12. The system of claim 11, wherein the schedule call back task delineator is capable of blocking a date slot for the agent so the agent is not assigned any other task on that date and the date is blocked for the agent owned recall outbound work.

13. The system of claim 11, wherein the schedule call back task delineator is capable of blocking a time slot for the agent so the agent is not assigned any other task at that time slot and the time slot is blocked for the agent owned recall outbound work.

14. The system of claim 13, wherein the task delineator is capable of blocking additional predefined time before the agent owned recall time slot.

15. A system, comprising a computer server, the computer server comprising a tangible computer readable medium, the medium comprising program instructions, wherein the program instructions are computer-executable to implement:
providing a work force management engine;
providing a searchable agent availability database accessible by the work force management engine;
receiving a parameter-specified request from a contact for agent owned recall availability data;
querying the work force management engine to determine agent owned recall availability data for the parameter-specified request;
reserving the agent owned recall availability slot for the parameter-specified request;
updating the work force management engine with the reserved parameter-specified agent owned recall availability slot data; and
confirming the agent owned recall availability slot with the contact of the parameter-specified request;
whereby the same agent is available to the contact for the agent owned recall.

16. The system of claim 15, wherein the parameter-specified request comprises a date slot or a time slot the agent is available for the agent owned recall.

17. The system of claim 15, wherein the parameter-specified request comprises a date and time slot the agent is available for the agent owned recall.

18. The system of claim 15, wherein, if during the querying step, an agent owned recall availability conflict exists with the parameter-specified request, the method further comprises suggesting to the contact an alternative to the parameter-specified request.

19. The system of claim 18, wherein, after suggesting an alternative, the agent owned recall availability conflict is resolved, the work force management engine is updated with the reserved parameter-specified agent owned recall availability slot data and the request is confirmed with the contact.

20. The system of claim 18, wherein, after suggesting an alternative, the agent owned recall availability conflict is not resolved, the method further comprises setting the expectations of the contact.
